(19) United States
(12) Patent Application Publication
(10) Pub. No.: US 2009/0077455 A1
(43) Pub. Date: Mar. 19, 2009

(54) TRANSMISSION SYSTEM

(75) Inventor: Seiji MIZUTANI, Moriyama-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/190,202

(22) Filed: Aug. 12, 2008

(30) Foreign Application Priority Data
Aug. 17, 2007 (JP) P2007-212883

(51) Int. Cl. G06F 11/00

(52) U.S. Cl. 714/807; 714/E11.001

(57) ABSTRACT

A frame format used to send a command in which high-reliability transmission is demanded includes an SFD area, an inverted header area, a normal data area, a normal check area, an inverted header area, an inverted data area, and an inverted check area. Command data and data obtained by inverting the command data are stored in the normal and inverted data areas, respectively. Similarly, pieces of response data (normal/inverted) are stored in each data area. Check codes used to check the header area and the data area is stored in the normal and inverted check areas, respectively. A receiving device performs a check by the normal and inverted check codes, compares the normal header area with the inverted header area, and compares the normal data area with the inverted data area. The receiving device normally performs reception when all the comparison results are correct.

This application claims priority from Japanese patent application P2007-212883, filed on Aug. 17, 2007. The entire contents of the aforementioned application is incorporated herein by reference.

### BACKGROUND OF THE INVENTION

1. Field of the Invention

The present invention relates to a transmission system which makes a high-reliability transmission.

2. Description of the Related Art

In a network system of an FA (Factory Automation), a PLC (Programmable Logic Controller) which controls production facilities and devices whose operations are controlled by the PLC are connected to a control-system network. The PLC and the devices product cyclically communication through the control-system network, thereby performing data sending and reception to control the production facilities.

A master slave 1:N communication system can be cited as an example of a data transmission system which sends and receives data between node devices constituting the system. The communication system includes one master and plural slaves. The master has a bus management function. The slave sends a response according to polling from the master.

FIG. 1A shows an example of a transmission protocol format in the transmission system. The protocol format sequentially includes a start frame delimiter (SFD) area, a header area, a data area, and a check (CRC) area from a leading end. The start frame delimiter is a frame synchronous code which indicates a start of a frame. The header includes pieces of information such as a frame destination, a source host, a type, and a data size. The data is defined by an application, and the data is contents to be sent. An FCS code which is of a frame check sequence is stored in the check area. The FCS code is used to check the header and the data.

FIG. 1B shows another example of the transmission protocol format. In the protocol format, a first check area is provided between the header area and the data area, and a second check area is provided following the data area. The FCS code used to check the header area is stored in the first check area, and the FCS code used to check the data area is stored in the second check area. Therefore, the slave can perform an FCS check to the header immediately after the header is received. Accordingly, the slave receives the data while preparing the response, so that responsiveness can be improved.

On the other hand, usually the high-reliability transmission protocol in which a data error undetected rate is remarkably improved compared with the single FCS is realized by making a data portion of the transmission protocol redundant in the field bus shown in FIG. 1. Specifically, inverted double-transmission data compare is effectively used and a normal FCS and an inverted FCS are checked, thereby realizing the high reliability. That is, as shown in FIG. 2, the high-reliability transmission protocol has a data structure in which normal data which is of original data contents to be transmitted and inverted data obtained by inverting the normal data are provided in the data portion while the check area where the FCS code for checking each data is stored is provided in each pieces of the normal data and the inverted data. The high-reliability transmission protocol can respond to the transmission protocol of FIG. 1B in which the check area in which the FCS code for checking the header area is stored is provided between the header area and the data area.

### SUMMARY OF THE INVENTION

(1) In accordance with an aspect of the invention, a transmission system which performs data transmission among a plurality of devices connected to a network, wherein a transmitting device includes a unit which sends a normal packet and an inverted packet to a receiving device, the normal packet including a normal header area, a normal data area, and a normal check area, the inverted packet including an inverted header area, an inverted data area, and an inverted check area. A check code used to check the normal header area and the normal data area is stored in the normal check area, and a check code used to check the inverted header area and the inverted data area is stored in the inverted check area. Further, the receiving device includes a normal check code comparison unit which compares a check code computed based on the received normal header area and the received normal data area with the check code stored in the normal check area; an inverted check code comparison unit which compares a check code computed based on the received inverted header area and the received inverted data area with the check code stored in the inverted check area; a header area comparison unit which compares the normal header area to the inverted header area; and a data area comparison unit which compares the normal data area with the inverted data area, the receiving device determines that a normal reception is performed when for all the comparison results are correct, and the receiving device captures the normal packet and the inverted packet.

In an embodiment, the normal (inverted) data area corresponds to a normal (inverted) data area and a normal (inverted) response data area. That is, in the embodiment, the transmitting device becomes the master for the sending of the command, and the transmitting device becomes the slave for the sending of the response. In the embodiment, the receiving device becomes the slave for the reception of the command, and the receiving device becomes the master for the reception of the response.

In the embodiment, the normal check code comparison unit corresponds to FCS-1 check units 14e and 23e, and the inverted check code comparison unit corresponds to FCS-2 check units 14f and 23f. In the embodiment, the header area comparison unit and the data area comparison unit are respectively realized by reception control units 14a and 23a, and the header area comparison unit and the data area comparison unit correspond to a portion which performs branch processing in processing steps S 17, S28, S18, and S29.

(2) In the transmission system according to the aspect of the invention, preferably the normal packet and the inverted packet are sent by one frame. In the embodiment, this can be realized by a frame format shown in FIG. 4.

(3) In the transmission system according to the aspect of the invention, preferably the normal packet and the inverted packet are sent by each different frame, each of the frames being correlated by ID information incorporated in each of the frames, and, in the receiving device, the normal packet and the inverted packet are combined based on the ID information, and the each comparison unit performs the comparison processing. In the embodiment, this can be realized by a frame format shown in FIG. 11.

(4) In the transmission system according to the aspect of the invention, preferably data in which high reliability is demanded is sent through communication by the normal packet and the inverted packet, and data in which high reliability is not demanded is set in a frame having a configuration identical to that of the normal packet.

(5) In the transmission system according to the aspect of the invention, preferably a unit which produces and sends the normal packet and the inverted packet in the transmitting device is formed by a communication controller ASIC, and each comparison unit in the receiving device is formed by a communication controller ASIC.

Accordingly, the invention can provide the high-reliability protocol in the transmission system in which the usual master slave 1:N communication system is performed in a predetermined communication cycle. That is, the normal packet and the inverted packet are separate and the check code is added to each of the normal packet and the inverted packet. Therefore, two areas, which are the normal check code area and the inverted check code area, are formed to simplify the frame configuration. Because each check code is used to collectively check the header area and data area, reliability is improved for the information stored in the header area. Additionally, because the frame configuration is simplified, the transmission protocol is easily performed by an ASIC.

### BRIEF DESCRIPTION OF THE DRAWINGS

FIG. 1 shows an example of a conventional frame format;

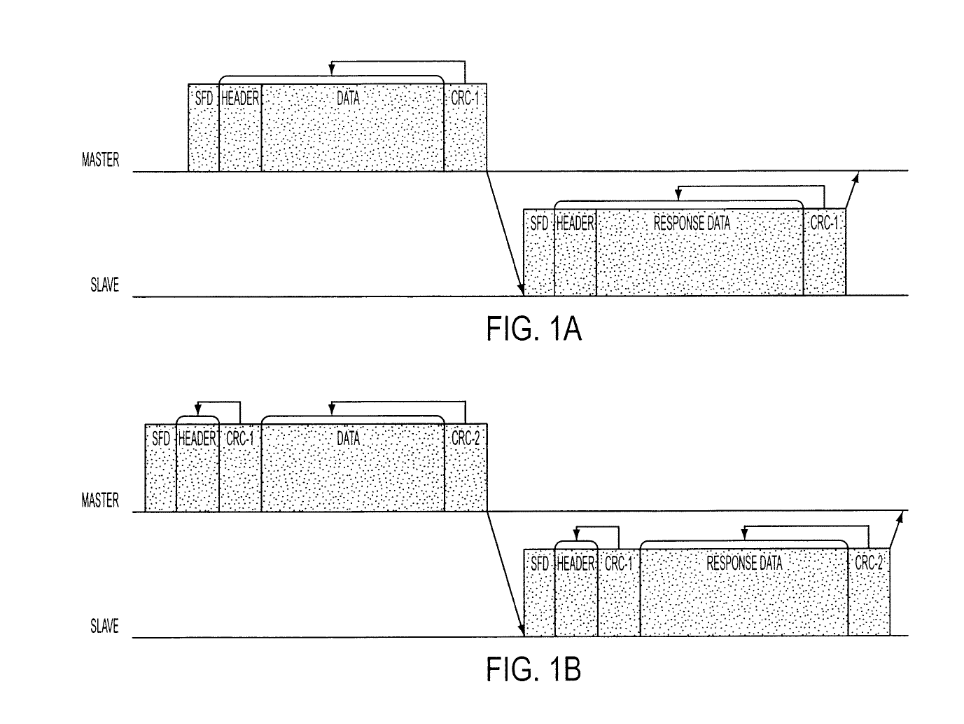

FIG. 2 shows another example of the conventional frame format;

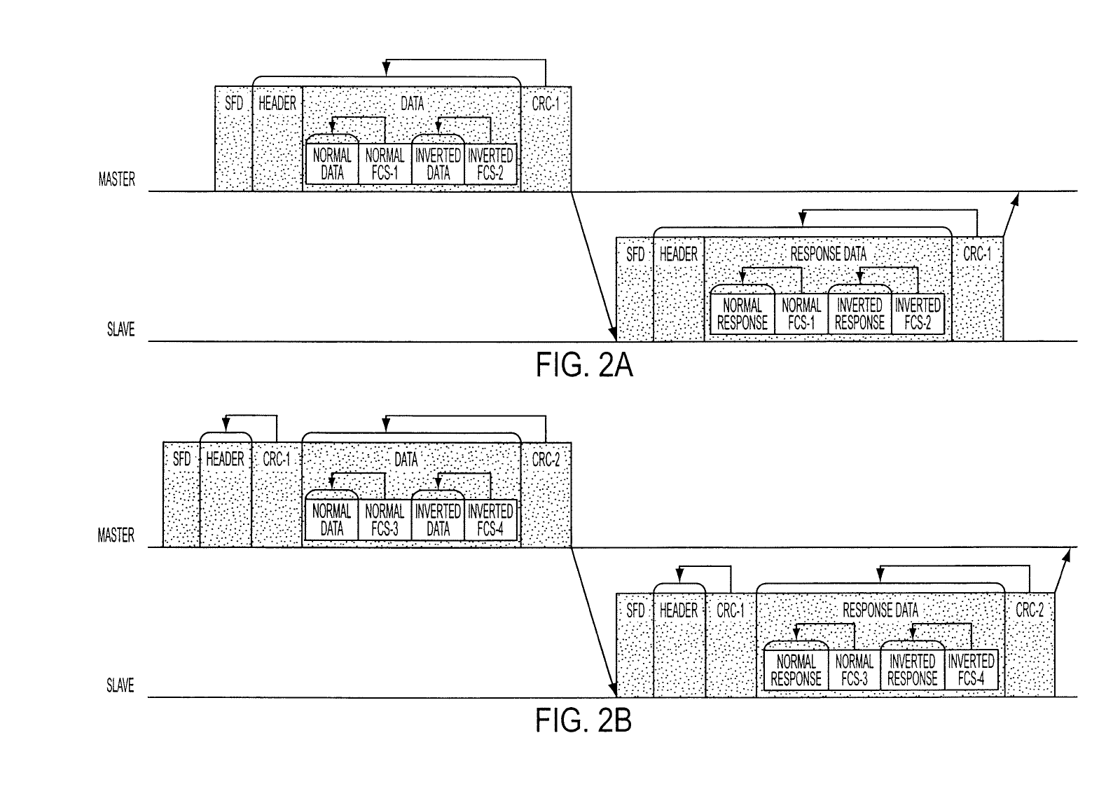

FIG. 3 shows an example of a network system according to an embodiment of the invention;

FIG. 4 shows an example of a high-reliability transmission frame format used in the embodiment;

FIG. 5 shows an example of an inside structures of a master and a slave;

FIG. 6 shows a flowchart of a function of a master-side sending unit;

FIG. 7 shows a flowchart of a function of a master-side reception unit;

FIG. 8 shows a flowchart of a function of a slave-side reception unit;

FIG. 9 shows a flowchart of a function of a slave-side sending unit;

FIG. 10 shows an example of a usual message transmission frame format used in the embodiment; and

FIG. 11 shows another example of the high-reliability transmission frame format used in the embodiment.

### DETAILED DESCRIPTION OF THE PREFERRED EMBODIMENTS

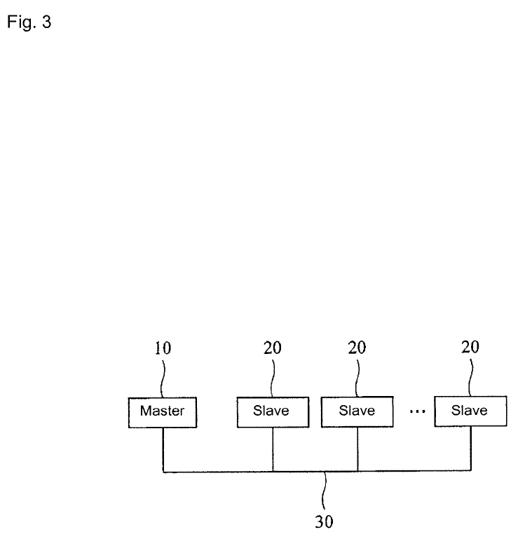

FIG. 3 shows an example of a transmission system according to an embodiment of the invention. In the system of the embodiment, a master 10 and plural slaves 20 are connected to a network such as a field bus 30. One node of the master 10 exists in the system, and has a bus management function. The plural slaves 20 send responses according to the polling from the master 10. For example, the master is realized by a master unit constituting a PLC, and the slave is realized by I/O terminals or devices which are connected to the field bus.

Conventionally, there is well known a control system in which a controller such as the PLC and the I/O terminals are connected through a network. The controller has a communication master function of conducting network communication with the I/O terminals.

In a case where the controller is a building block type controller formed by coupling plural unit chassis (such as a power supply unit, a CPU unit, an I/O unit, and a communication unit), the communication master function is incorporated in a communication master unit. Sometimes the communication master unit is referred to as “master station”, “master unit”, or “master”.

The I/O terminal has a network communication function, that is, a communication slave function with the communication master function of the controller. The VO terminal includes a connection terminal, and the connection terminal is connected to at least one of an input device such as a switch which supplies an on-off signal and an output device which constitutes an output destination of a control signal. Examples of the input device include a stop switch, a door switch, and a two-hand switch. Examples of the output device include a relay and a contactor. The I/O terminal produces control data based on a signal fed from the connected device, and the I/O terminal supplies the produced control data to the controller through the network communication.

In a case where the controller is the building block type controller, each unit is connected to a common internal bus, and each unit sends and receives data to and from a CPU unit by conducting bus communication with the CPU unit which controls the whole of the controller. The coupled I/O unit also includes the connection terminal, and the input device or the output device is connected to the connection terminal. An input signal of the input device is fed into the controller from the I/O terminal through the communication master unit by the network communication with, or an input signal of the input device connected to the coupled I/O unit is fed into the controller, and the controller executes a previously-stored logic program to perform a logic operation of the on and off of the input signal. The controller supplies the output signal based on the operation result to the I/O terminal through the communication master unit by the network communication or the controller supplies the output signal to the coupled I/O terminal. The I/O unit and the I/O terminal supply the output signal to the output device. The controller controls the whole system including a production robot by repeatedly performing the series of operations.

The communication cycle between the controller and the I/O terminal may be synchronous or asynchronous with the repetitive cycle performed by the controller. A logic program which becomes an object of logic operation processing in the controller or the CPU unit is previously produced by a programmer. For example, a ladder notation, a mnemonic notation, and a function block notation may be used for a programming description in producing the logic program. In terms of a programming language, an interpreter type language, a script language, an assembly language, a high-level language, a Java language may be used. Assembling processing, compiling processing, or the like is performed to a source code written in the programming language, and a CPU executes the logic program.

The relay or contactor which is of the output device connected to the I/O terminal is connected to a production robot or a processing machine, the production robot and the like are operated while the contact of the relay or contactor is turned on, and the production robot and the like are stopped while the contact is turned off. Therefore, the controller controls the turn-on and off of the output device, thereby controlling the operation and stop of the production robot and the like which are of the final control object. Specifically, when the I/0 terminal notifies the controller that the stop switch is normally manipulated through the communication, the controller performs processing for turning off the output device (relay or contactor).

In the transmission system shown in FIG. 3, the master 10 manages the communication cycle. The master 10 sequentially delivers a polling frame (frame sent from the master to the slave) to the slaves 20, the slave 20 performs reception processing when receiving the frame to own station, and the slave 20 sends a response (frame sent back from the slave to the master). The master 10 performs the polling to all the slaves 20 within a predetermined time, thereby conducting the communication with all the slaves 20 in a predetermined period. The predetermined period is referred to as communication cycle.

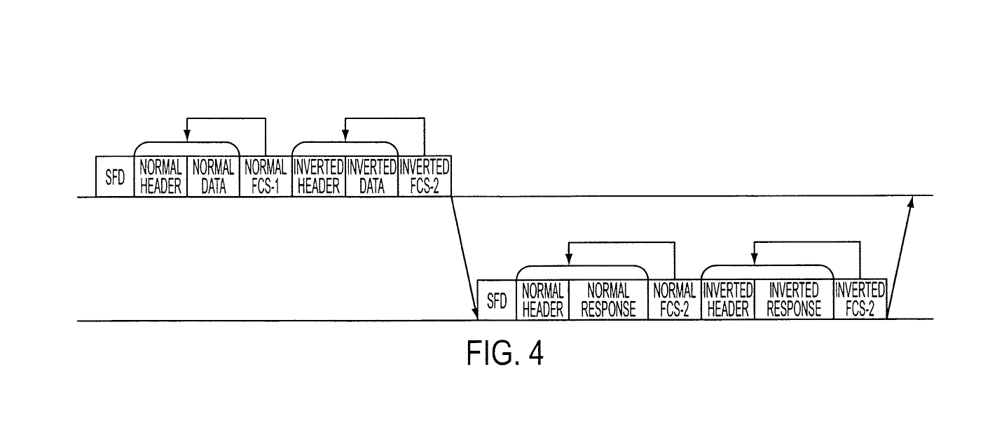

FIG. 4 shows an example of a high-reliability transmission frame format used in the transmission system. A protocol format of a polling frame sent from the master 10 sequentially includes a start frame delimiter (SFD) area, a normal header area, a normal data area, a normal check area, an inverted header area, an inverted data area, and an inverted check area. The start frame delimiter is a frame synchronous code indicating a start of the frame.

A forwarding destination slave address, a frame type (distinction between “command” and “response”), a frame class, and a data size are stored in the normal header area. Examples of the class specified by the frame class include “high-reliability transmission” and “message transmission”. Because the format shown in FIG. 4 is used in a high-reliability transmission message, the frame class in this case becomes a code for specifying “high-reliability transmission”. The normal data stored in the normal data area is defined by an application, and the normal data is contents to be actually sent from the master to the slave. The FCS code is stored as a frame sequence check in the normal check area. The normal FCS code is used to check the normal header and the normal data (computation covers a range of the normal header to the normal data when the code is obtained).

Similarly, data which is obtained by inverting the data stored in the normal header area is stored in the inverted header area. The inverted data stored in the inverted data area is data which is obtained by inverting the normal data. The FCS code is stored as a frame check sequence in the inverted check area. The inverted FCS code is used to check the inverted header and the inverted data (computation covers a range of the inverted header to the inverted data when the code is obtained).

On the other hand, a protocol format of a response frame sent from the slave 20 sequentially includes a start frame delimiter (SFD) area indicating the start of the frame, a normal header area, a normal response data area, a normal check area, an inverted header area, an inverted response area, and an inverted check area. A master address which is of a forwarding destination of the response is stored in the normal header area. Response data addressed to the master from the slave is stored in the normal response data area. Data which is obtained by inverting the normal header area is stored in the inverted header area. Data which is obtained by inverting the response data stored in the normal response data area is stored in the inverted response data area. The FCS code used to check the corresponding header area and response data is stored in the check area.

Therefore, in the format having the above configuration, the receiving device performs each of the inverted double-transmission data compare and the FCS check only two times for the normal and inverted areas. Because the header information is also the object of the inverted double-transmission data compare, a possibility that an error is generated in the frame class or the destination information becomes remarkably low, and the high reliability can also be ensured in the header. That is, a possibility that the frame addressed to another station is mistakenly received becomes remarkably low, and mixture with a later-mentioned message transmission format is hardly generated. Thus, the high-reliability transmission can be ensured by the simple format structure, and the processing can easily be realized with an ASIC.

FIG. 4 shows the master-slave communication between the master and one slave, and the command and the response are repeatedly sent and received in each slave.

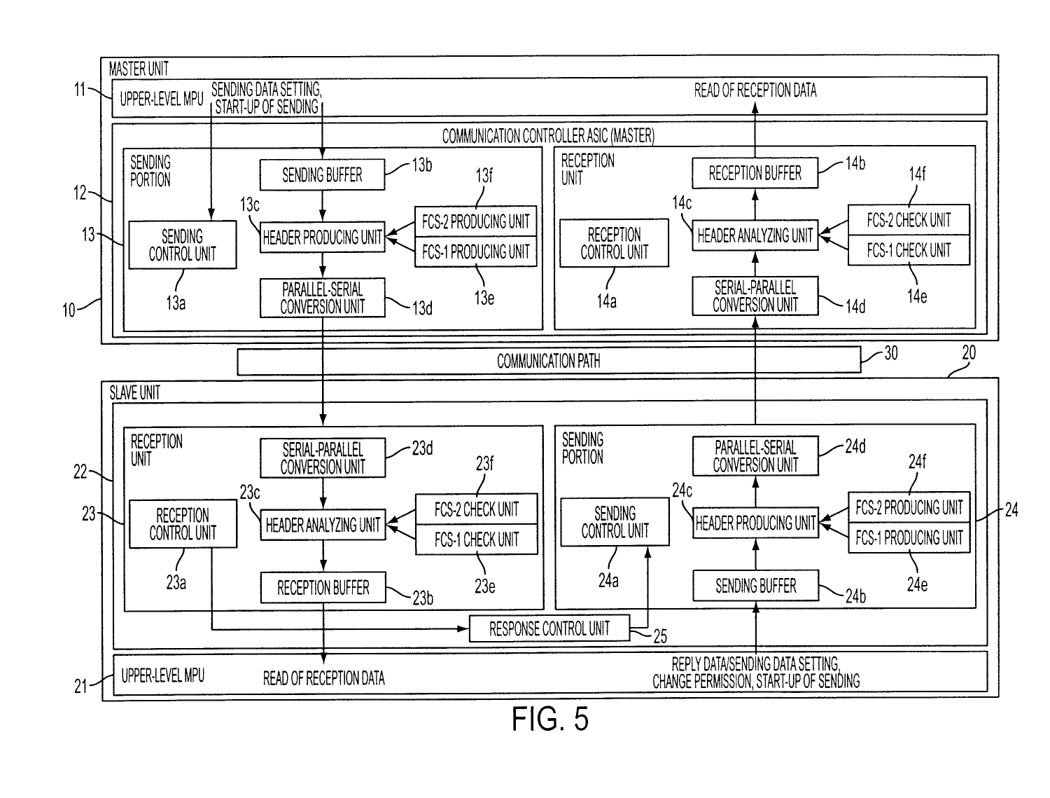

FIG. 5 shows an inside structures of the master 10 and the slave 20. The master 10 includes a MPU 11 and a communication controller ASIC 12 which performs the communication control. Similarly, the slave 20 includes a MPU 21 and a communication controller ASIC 22 which performs the communication control. Only the function used to perform the master-slave communication is shown in both the master 10 and the slave 20. In addition, for example, the hardware configuration includes a RAM which is used as a work memory when the MPUs 11 and 21 perform the computation and a ROM in which various programs are stored.

Functions of the MPU 11 and communication controller ASIC 12 and an operation on the side of the master 10 will be described below. When the data to be sent is generated in executing various applications, the MPU 11 sets the sending data to make a request to the communication controller ASIC 13 to send the data. When the data to be sent is one in which high-reliability transmission should be performed, the MPU 11 produces the inverted data obtained by inverting the regular data (normal data) to be sent, and stores the inverted data in the sending buffer. The MPU 11 obtains the data (such as response) received by the communication controller ASIC 12.

From the standpoint of function, the communication controller ASIC 12 includes the sending unit 13 and the reception unit 14. The sending unit 13 includes a sending control unit 13a, a sending buffer 13b, a header producing unit 13c, a parallel-serial conversion unit 13d, an FCS-1 producing unit 13e, and an FCS-2 producing unit 12f. The reception unit 14 includes a reception control unit 14a, a reception buffer 14b, a header analyzing unit 14c, a parallel-serial conversion unit 14d, an FCS-1 check unit 14e, and an FCS-2 check unit 14f.

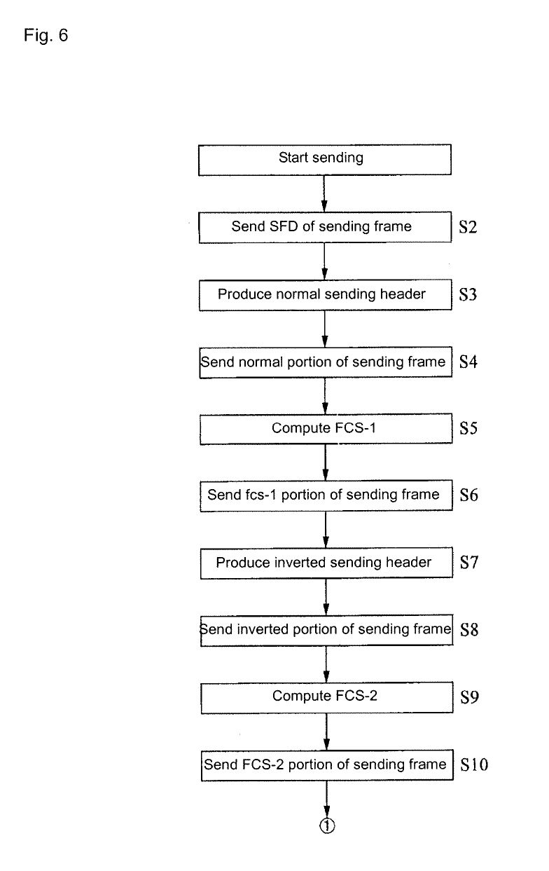

When the sending control unit 13a receives the sending request from the MPU 11, the sending control unit 13a operates each processing unit according to a flowchart of FIG. 6 to send the high-reliability transmission protocol frame. The data given from the MPU 11 is tentatively stored in the sending buffer 13b. That is, the data stored in the normal data area of FIG. 4 is retained in the sending buffer 13b. The header producing unit 13c stores a destination of the sending frame based on the information obtained from the MPU 11. The FCS-2 producing unit 13f and the FCS-1 producing unit 13e compute FCSs of the normal data and inverted data to deliver the produced FCS codes to the header producing unit 13c. That is, the header producing unit 13c has a function of producing the header information constituting the frame and a function of producing the sending frame based on the data obtained from each processing unit to deliver the sending frame to the subsequent parallel-serial conversion unit 13d. The parallel-serial conversion unit 13d performs parallel-serial conversion to the given data, and then sends the converted data to the field bus 30 as the serial signal.

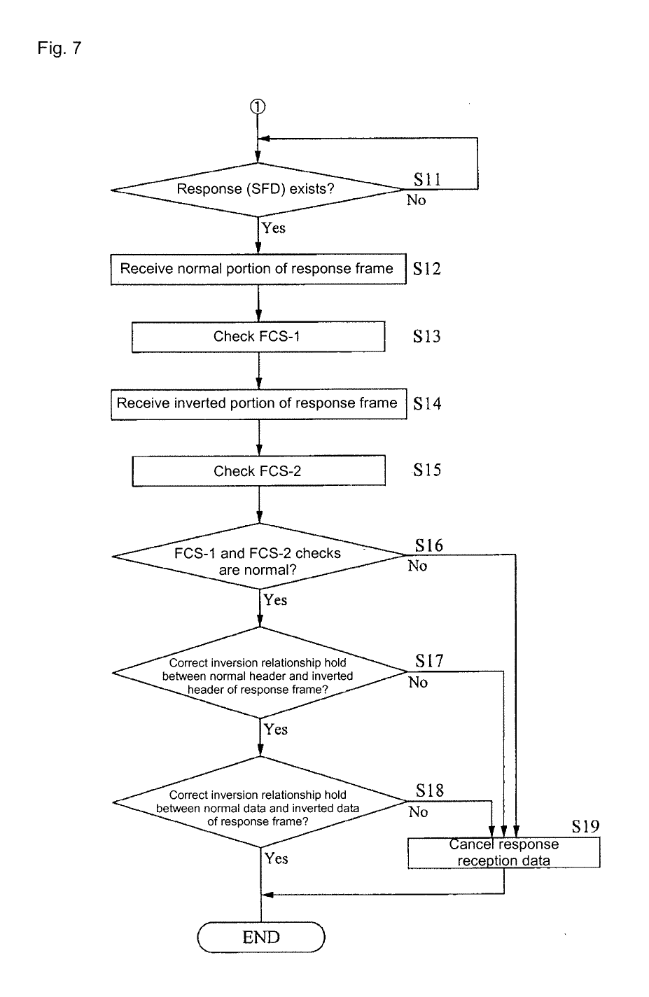

On the other hand, the reception control unit 14a operates each processing unit according to a flowchart of FIG. 7 to receive the response sent from the slave, and the reception control unit 14a delivers the data stored in the received response to the MPU 11. The parallel-serial conversion unit 14d converts the serial signal received from the field bus 30 into a parallel signal. The header analyzing unit 14c analyzes the data stored in the header area of the received response reception data, and then determines whether or not the response reception data is the response to the own address. The FCS-1 check unit 14e and the FCS-2 check unit 14f compute FCS of the normal portion or inverted portion of the received data to check whether or not the computed FCS is matched with the FCS code stored in the frame. The received frame data is tentatively stored in the reception buffer 14b. When it is determined that the received frame data is regular frame data, the MPU 11 reads the predetermined data stored in the reception buffer 14b.

The specific sending processing and reception processing performed by the processing units of the master 10 will be described with reference to FIGS. 6 and 7. The simple command sending processing and response reception processing of the master are shown in the following description. Time-up processing in waiting for the response and processing in receiving an abnormal response code such as NAK as the response, which are frequently performed in the usual communication protocol, are omitted for the sake of convenience.

The MPU 11 sets the sending data, and provides a sending start-up command to the communication controller ASIC 12. At this point, the MPU 11 sends the class (high-reliability transmission) of the sending frame and the information on the other party in addition to the sending normal data and inverted data. The inverted data may be produced on the side of the communication controller ASIC 12 which receives the normal data. The communication controller ASIC 12 starts the sending processing when receiving the sending start-up command.

The sending control unit 13a produces and sends an SFD for the sending frame obtained from the MPU 11 (S2). The actual sending processing is performed after the parallel-serial conversion unit 13d converts the frame data into the serial signal (the same holds true for the following description).

The header producing unit 13c produces the sending header (normal header) used to send the normal data based on the information on the destination obtained from the MPU 11 (S3). That is, the header producing unit 13c produces the data stored in the normal header area, and the data includes “forwarding destination slave address”, “command” (frame type), “high-reliability transmission” (frame class), and “data size”. For example, the data size can be obtained based on the normal data stored in the sending buffer 13b. Obviously the data size may be obtained from the MPU 11.

The normal portion of the sending frame is sent (S4). The normal portion includes the produced normal header and the normal data (stored in sending buffer 13b) given from the MPU 11.

The FCS-1 producing unit 13e computes FCS-1 of the normal portion sent in processing step S4 (S5). The obtained FCS-1 is sent as the data of the normal check area of the sending frame (S6). Contents of each of processing steps S1 to S6 may be similar to those in a case of the sending of the usual frame (FCS ranges from the header to the sending data) which is not the high-reliability transmission. When the flowchart of FIG. 6 is performed up to processing step S6, the sending is completed from the master of FIG. 4 for the SFD area, normal header area, normal data area, and normal check area portion in the sending frame.

Then, the flowchart makes a transition to the inverted data sending processing. The header producing unit 13c produces the sending header (inverted header) used to send the inverted data based on the information on the destination obtained from the MPU 11 (S7). That is, the data of the inverted header is produced by inverting the normal header produced in processing step S3.

The inverted portion of the sending frame is sent (S8). The inverted portion includes the produced inverted header and the inverted data (stored in sending buffer 13b) given from the MPU 11.

The FCS-2 producing unit 13f computes FCS-2 of the inverted portion sent in processing step S8 (S9). The obtained FCS-2 is sent as the data of the inverted check area of the sending frame (S10). When the flowchart of FIG. 6 is performed up to processing step S10, the sending is completed from the master of FIG. 4 for the whole of the sending frame.

When the destination slave receives the frame sent according to the flowchart of FIG. 6, the slave sends the response. The response can be captured by performing the flowchart of FIG. 7.

The reception unit 14 (reception control unit 14a) waits for the reception of the response SFD (S11). When the response SFD is received, the reception unit 14 is synchronized with the response SFD to receive the normal portion of the response frame subsequent to the response SFD (S12). Specifically, the frame data (serial) transmitted on the field bus 30 is converted into the parallel signal by the serial-parallel conversion unit 14d, and the parallel signal is delivered to the header analyzing unit 14c. The header analyzing unit 14c analyzes the normal header area, and the reception unit 14 receives the response to the own address stored in the normal header area.

When the normal portion of the response to the own address is received, the FCS-1 check unit 14e obtains an FCS in the range of the normal header to the normal data to check whether or not the obtained FCS is matched with the FCS code stored in the normal check area (S13).

Similarly, the FCS-2 check unit 14f receives the inverted portion of the response frame which is sent subsequent to the normal portion, and checks an FCS of the data of the received inverted portion (S14 and S15). The received response reception data is stored in the reception buffer 14b.

The reception control unit 14a determines whether or not the FCS checks of the normal portion and inverted portion are normal from the check results of the check units 14e and 14f (S16). When at least one of the FCS checks is abnormal, the response reception data tentatively stored in the reception buffer 14b is cancelled (S19).

The reception control unit 14a compares the normal header and inverted header of the response frame to determine whether or not the correct inversion relationship holds (S17). When the correct inversion relationship does not hold, the response reception data tentatively stored in the reception buffer 14b is cancelled (S19).

The reception control unit 14a compares the normal data and inverted data of the response frame to determine whether or not the correct inversion relationship holds (S18). When the correct inversion relationship does not hold, the response reception data tentatively stored in the reception buffer 14b is cancelled (S19).

When all the branching determinations in processing steps S16, S17, and S18 are correct, the received response is accepted as a regular response. That is, the MPU 11 obtains the response reception data (normal data) stored in the reception buffer 14b.

Functions of the MPU 21 and the communication controller ASIC 22 and an operation on the side of the master 20 will be described below. When the MPU 21 receives a command from the master 10 through the communication controller ASIC 22, the MPU 21 performs processing relating to the command to produce the response data, and issues a sending start-up command while setting the response data in the communication controller ASIC 22. In the embodiment, because the command sent from the master is also sent in the high-reliability transmission frame, the response frame also becomes the high-reliability transmission frame. Therefore, the MPU 21 also produces the data obtained by inverting the response data along with the regular data (normal data) to be replied, and stores the inverted response data in the sending buffer.

From the standpoint of function, the communication controller ASIC 22 includes a reception unit 23, a sending unit 24, and a response control unit 25. The reception unit 23 includes a reception control unit 23a, a reception buffer 23b, a header analyzing unit 23c, a serial-parallel conversion unit 23d, an FCS-1 check unit 23e, and an FCS-2 check unit 23f. The sending unit 24 includes a sending control unit 24a, a sending buffer 24b, a header producing unit 24c, a parallel-serial conversion unit 24d, an FCS-1 producing unit 24e, and an FCS-2 producing unit 24f.

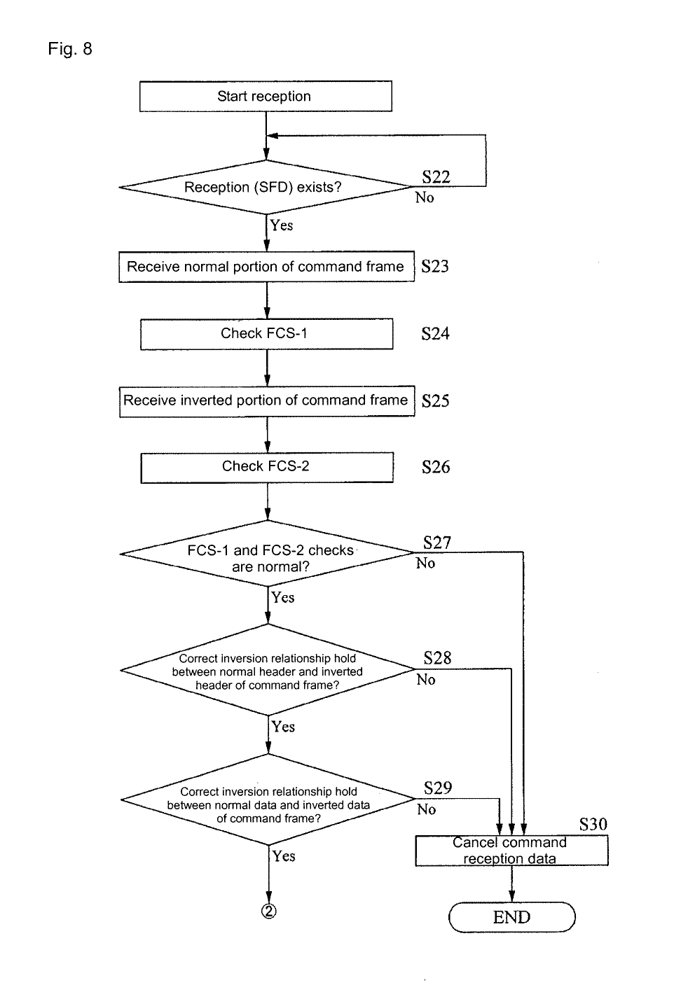

The reception control unit 23a operates each processing unit according to a flowchart of FIG. 8, and receives the command frame sent from the master while delivering the data stored in the received command to the MPU 21. The serial-parallel conversion unit 23d converts the serial signal received from the field bus 30 into the parallel signal. The header analyzing unit 23c analyzes the data stored in the normal header area of the received command frame, and determines whether or not the received command frame is the command to the own address. The FCS-1 check unit 23e and the FCS-2 check unit 23f compute an FCS of the normal portion or inverted portion of the received data to check whether or not the computed FCS is matched with the FCS code stored in the frame. The received frame data is tentatively stored in the reception buffer 23b. When the FCS-1 check unit 23e and the FCS-2 check unit 23f determine that the received data is the regular frame data, the MPU 11 reads the predetermined data stored in the reception buffer 23b.

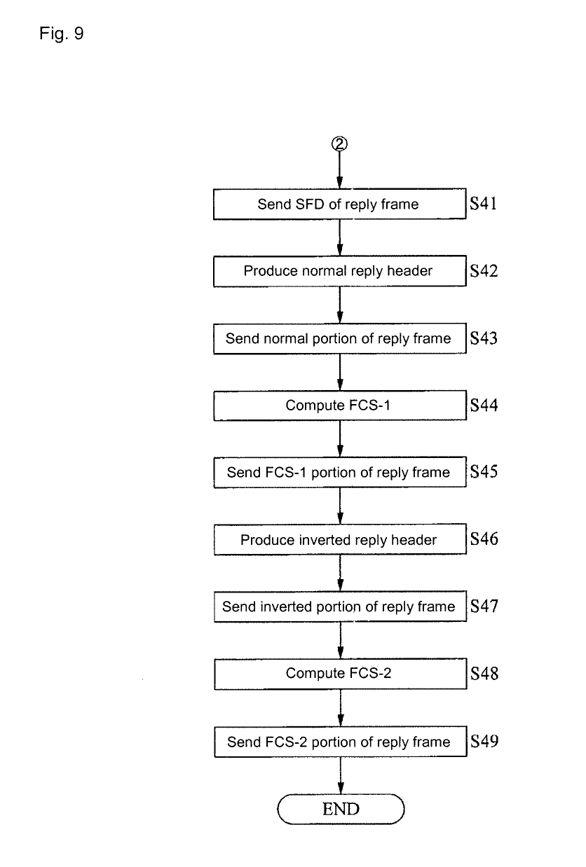

On the other hand, when the sending control unit 24a receives the response sending request from the response control unit 25, the sending control unit 24a operates each processing unit according to a flowchart of FIG. 9 to send the response frame of the high-reliability transmission protocol. The response data given from the MPU 21 is tentatively stored in the sending buffer 24b. That is, the data stored in the normal response data area of FIG. 4 is tentatively stored in the sending buffer 24b. The header producing unit 24c stores the destination of the sending frame based on the information obtained from the response control unit 25.

The FCS-1 producing unit 24e and the FCS-2 producing unit 24f compute FCSs of the normal response data and inverted response data to deliver the produced FCS codes to the header producing unit 24c. That is, the header producing unit 24c has a function of producing the header information constituting the frame and a function of producing the sending frame based on the data obtained from each processing unit to deliver the sending frame to the subsequent parallel-serial conversion unit 24d. The parallel-serial conversion unit 24d performs parallel-serial conversion to the given data, and then sends the converted data to the network 30 as the serial signal.

When the reception unit 23 (reception control unit 23a) receives the command frame from the master, the response control unit 25 receives the information that the reception unit 23 receives the command frame from the master and the information on the address of the master which becomes a reply address of the response, and the response control unit 25 provides an instruction to the sending control unit 24a to send the response to the command.

The specific command reception processing and corresponding response sending processing performed by the processing units of the slave 20 will be described with reference to FIGS. 8 and 9. The simple command reception processing and response sending processing of the master are shown in the following description. NAK response return processing and abnormal processing for sending a BUSY response in a case where the response data is not prepared, which are frequently performed in association with an FCS check error of the command in the usual communication protocol, are omitted for the sake of convenience.

The reception unit 23 (reception control unit 23a) waits for the reception of the command frame SFD (S22). When the command frame SFD is received, the reception unit 23 is synchronized with the command frame SFD to receive the normal portion of the command frame subsequent to the command frame SFD (S23). Specifically, the frame data (serial) transmitted on the field bus 30 is converted into the parallel signal by the serial-parallel conversion unit 23d, and the parallel signal is delivered to the header analyzing unit 23c. The header analyzing unit 23c analyzes the normal header area, and receives the command frame to the own address stored in the normal header area.

When the normal portion of the command frame to the own address is received, the FCS-1 check unit 23e obtains an FCS in the range of the normal header to the normal data to check whether or not the obtained FCS is matched with the FCS code stored in the normal check area (S24).

Similarly, the FCS-2 check unit 23f receives the inverted portion of the command frame which is sent subsequent to the normal portion, and checks an FCS of the data of the received inverted portion (S25 and S26). The reception data of the received command frame is stored in the reception buffer 23b.

The reception control unit 23a determines whether or not the FCS checks of the normal portion and inverted portion are normal from the check results of the check units 23e and 23f (S27). When at least one of the FCS checks is abnormal, the command reception data tentatively stored in the reception buffer 23b is cancelled (S30).

The reception control unit 23a compares the normal header and inverted header of the command frame to determine whether or not the correct inversion relationship holds (S28). When the correct inversion relationship does not hold, the command reception data tentatively stored in the reception buffer 23b is cancelled (S30).

The reception control unit 23a compares the normal data and inverted data of the command frame to determine whether or not the correct inversion relationship holds (S29). When the correct inversion relationship does not hold, the command reception data tentatively stored in the reception buffer 23b is cancelled (S30).

When all the branching determinations in processing steps S27, S28, and S29 are correct, the received response is accepted as the regular response. That is, the MPU 21 obtains the command reception data (normal data) stored in the reception buffer 23b. The MPU 21 performs predetermined processing according to contents of the obtained command, and then produces the response data (normal response data and inverted response data) to the command to set the response data in the sending buffer 24b. The reception control unit 23a sends the information that the command frame is normally received and the information necessary to send the response to the response control unit 25.

The sending control unit 24a produces and sends an SFD for the sending frame used to send the response data obtained from the response control unit 25 (S41). The actual sending processing is performed after the parallel-serial conversion unit 24d converts the frame data into the serial signal (the same holds true for the following description).

The header producing unit 24c produces the sending header (normal header) used to send the normal data based on the information on the destination obtained from the response control unit 25 (S42). That is, the header producing unit 24c produces the data stored in the normal header area, and the data includes “forwarding destination master address”, “response” (frame type), “high-reliability transmission”(frame class), and “data size”. For example, the data size can be obtained based on the normal data stored in the sending buffer 24b. Obviously the data size is obtained from the MPU 21.

The normal portion of the sending frame is sent (S43). The normal portion includes the produced normal header and the normal data (stored in sending buffer 24b) given from the MPU 21.

The FCS-1 producing unit 24e computes an FCS-1 of the normal portion sent in processing step S43 (S44). The obtained FCS-1 is sent as the data of the normal check area of the sending frame (S45). When the flowchart of FIG. 9 is performed up to processing step S45, the sending is completed from the slave 20 of FIG. 4 for the SFD area, normal header area, normal response data area, and normal check area portion in the response sending frame.

Then, the flowchart makes a transition to the inverted data sending processing. The header producing unit 24c produces the data (inverted header) obtained by inverting the data stored in the normal header area based on the information on the destination obtained from the response control unit 25 (S46).

The inverted portion of the sending frame is sent (S47). The inverted portion includes the produced inverted header and the inverted data (stored in sending buffer 24b) given from the MPU 21.

The FCS-2 producing unit 24f computes an FCS-2 of the inverted portion sent in processing step S47 (S48). The obtained FCS-2 is sent as the data of the inverted check area of the sending frame (S49). When the flowchart of FIG. 9 is performed up to processing step S49, the sending is completed from the slave of FIG. 4 for the whole of the response sending frame.

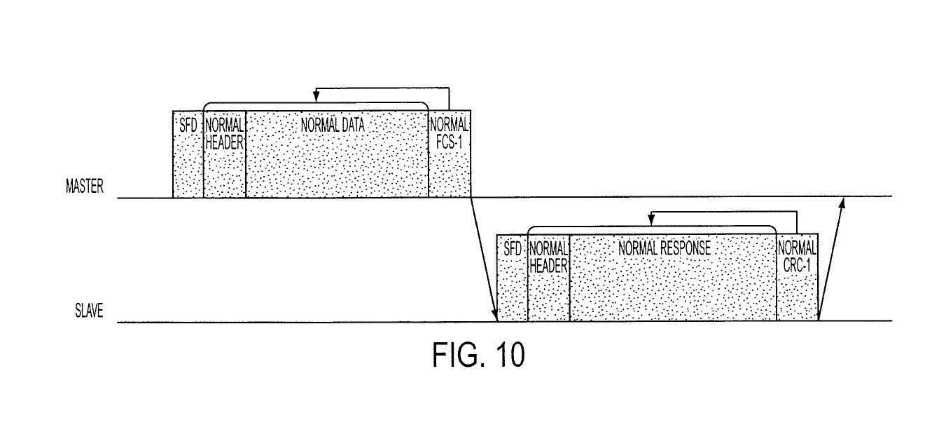

FIG. 10 shows an example of a message transmission protocol format used in the embodiment. As is clear from the comparison with FIG. 4, the normal portion of FIG. 10 has the configuration similar to that of the high-reliability transmission protocol format. Thus, because the normal portion of FIG. 10 has the configuration similar to that of the high-reliability transmission protocol format, the transmission is performed only by the format of the normal data portion. Therefore, the framing processing logic circuit and the reception analyzing processing logic circuit are shared by the communication controller ASICs, so that the message information can be transferred at a usual reliability level while transmission is performed by the high-reliability frame.

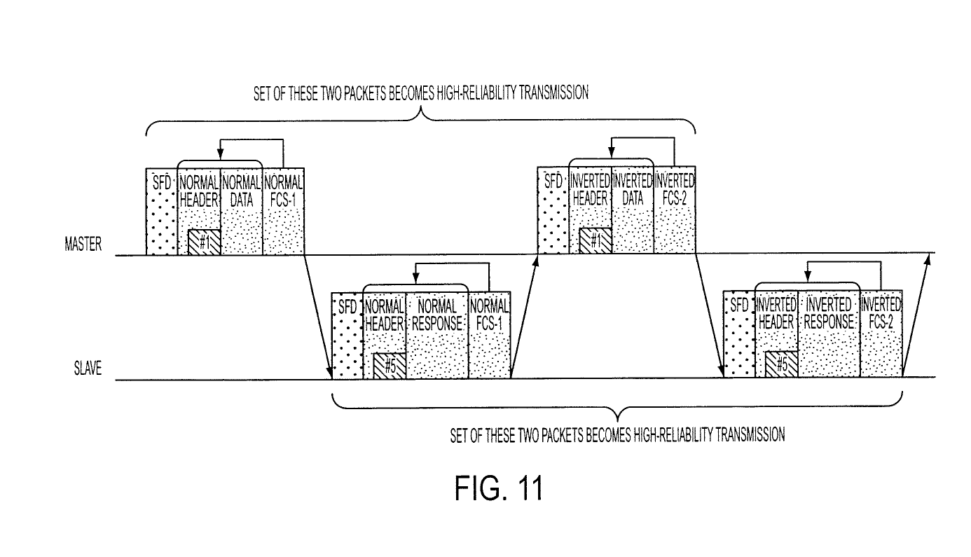

FIG. 11 shows another format of the high-reliability transmission protocol used in the embodiment. In FIG. 11, the normal command data (normal response data) and the inverted command data (inverted response data) are sent by each different frame. That is, one format is formed by “SFD area, header area, data (response) area, and check area”. The pair of normal portion frame and the inverted portion frame is correlated with each other by writing an ID number in the header area. In FIG. 11, the command frames are correlated by setting ID=#1, and the response frames are correlated by setting ID=#5. On the receiving device, the corresponding frames are correlated to each other by the ID number, the determination whether the high-reliability transmission frame is correctly received is made, and the reception data is captured or cancelled according to the determination.

The embodiment supports the two formats, that is, “high-reliability transmission protocol format” of FIG. 4 and “message transmission protocol format” of FIG. 10. As shown in FIG. 11, the ID number is added to the frame to establish the set of (at least two) plural packets, so that the transmission having the high reliability equal to the high-reliability transmission protocol format can be performed while the one format is supported. The transmission having the reliability higher than that of the format of FIG. 4 can be performed by forming the one set with at least three frames.

In a case where the normal portion and the inverted portion are sent by each different frame as shown in FIG. 11, it is necessary that the receiving device address and the like be correctly put in the inverted header area of the frame of the inverted portion. Therefore, the same contents (forwarding destination slave address, frame type, frame class, and data size) are written in the data stored in the normal header area and the data stored in the inverted header area. Accordingly, in the comparison of the normal header area and the inverted header area in the receiving device (S17 and S28), the affirmative determination is made based on not “inverted state” but “the same state”.

Alternatively, in order that the receiving device recognizes whether the received frame belongs to the normal portion or the inverted portion, a normal or inverted determination bit is set as the data stored in the header area, the determination bit is added when the transmitting device produces the header area, and the receiving device recognizes the determination bit when analyzing the header area, whereby the receiving device can determine whether the normal or inverted data is received. Alternatively, different SFDs may be used in the normal frame and the inverted frame.

What is claimed is:

1. A transmission system which performs data transmission among a plurality of devices connected to a network,
wherein a transmitting device includes a unit which sends a normal packet and an inverted packet to a receiving device, the normal packet including a normal header area, a normal data area, and a normal check area, the inverted packet including an inverted header area, an inverted data area, and an inverted check area,
a check code used to check the normal header area and the normal data area being stored in the normal check area, and a check code used to check the inverted header area and the inverted data area being stored in the inverted check area, and
the receiving device includes:
a normal check code comparison unit which compares a check code computed based on the received normal header area and the received normal data area with the check code stored in the normal check area;
an inverted check code comparison unit which compares a check code computed based on the received inverted header area and the received inverted data area with the check code stored in the inverted check area;
a header area comparison unit which compares the normal header area with the inverted header area; and
a data area comparison unit which compares the normal data area with the inverted data area,
wherein the receiving device determines that a normal reception is performed when all the comparison results are correct, and
the receiving device captures the normal packet and the inverted packet.

2. The transmission system according to claim 1, wherein the normal packet and the inverted packet are sent by one frame.

3. The transmission system according to claim 1, wherein the normal packet and the inverted packet are sent by each different frame, each of the frames being correlated by ID information incorporated in each of the frames and
in the receiving device, the normal packet and the inverted packet are combined based on the ID information, and the each comparison unit performs the comparison processing.

4. The transmission system according to claim 1, wherein data in which high reliability is demanded is sent through communication by the normal packet and the inverted packet, and
data in which high reliability is not demanded is sent in a frame having a configuration identical to that of the normal packet.

5. The transmission system according to claim 1, wherein the unit which produces and sends the normal packet and the inverted packet in the transmitting device is formed by a communication controller ASIC, and
each comparison unit in the receiving device is formed by a communication controller ASIC.

6. The transmission system according to claim 4, wherein the unit which produces and sends the normal packet and the inverted packet in the transmitting device is formed by a communication controller ASIC, and
each comparison unit in the receiving device is formed by a communication controller ASIC.
